(19) United States
(12) Patent Application Publication
(10) Pub. No.: US 2026/0321587 A1
(43) Pub. Date: Oct. 15, 2026

(54) SILICON COMPOSITE NEGATIVE ELECTRODE MATERIAL FOR LITHIUM SECONDARY BATTERY INCLUDING LITHIUM SILICATE MATRIX, METHOD FOR PREPARING THE SAME AND NEGATIVE ELECTRODE FOR LITHIUM SECONDARY BATTERY INCLUDING THE SAME

(71) Applicant: SILI ENERGY INC., Daejeon (KR)

(72) Inventor: KYOUNG JIN JEONG, Seoul (KR)

(21) Appl. No.: 18/835,802

(22) PCT Filed: May 10, 2024
(86) PCT No.: PCT/KR2024/006304

§ 371 Date: Aug. 5, 2024

(30) Foreign Application Priority Data
Nov. 29, 2023 (KR) 10-2023-0168870

(51) Int. Cl. H01M 4/36; H01M 4/02; H01M 4/04; H01M 4/134; H01M 4/136; H01M 4/38; H01M 4/58; H01M 4/62; H01M 10/052

(52) U.S. Cl. CPC H01M 4/364; H01M 4/0471; H01M 4/134; H01M 4/136; H01M 4/386; H01M 4/5825; H01M 4/625; H01M 10/052; H01M 2004/021; H01M 2004/027

(57) ABSTRACT

A composite negative electrode material for a lithium secondary battery includes a lithium silicate matrix and silicon. The composite negative electrode material can provide a lithium secondary battery with improved performance, since large volumetric swelling of silicon occurring during charging/discharging can be inhibited by virtue of the lithium silicate matrix.

### CROSS REFERENCE TO RELATED APPLICATIONS AND CLAIM OF PRIORITY

This application claims benefit under 35 U.S.C. 119, 120, 121, or 365(c), and is a National Stage entry from International Application No. PCT/KR2024/006304 filed on May 10, 2024, which claims priority to the benefit of Korean Patent Application No. 10-2023-0168870 filed on Nov. 29, 2023 in the Korean Intellectual Property Office, the entire contents of which are incorporated herein by reference.

### BACKGROUND

### 1. Technical Field

The present disclosure relates to a composite negative electrode material for a lithium secondary battery including a lithium silicate matrix, a method for preparing the same, and a lithium secondary battery including the same.

### 2. Background Art

As technological development and needs for mobile instruments have been increased, secondary batteries as energy sources have been increasingly in demand rapidly. Among such secondary batteries, lithium secondary batteries using a mechanism of lithium-ion intercalation, having high energy density and voltage and showing long cycle life have been commercialized and used widely.

A lithium secondary battery includes a positive electrode, a negative electrode, a separator interposed between the positive electrode and the negative electrode to separate both electrodes from each other, and an electrolyte communicating electrically with the positive electrode and the negative electrode.

Such a lithium secondary battery is generally obtained by using a lithium-containing compound, such as LiCoO₂ or LiMn₂O₄, for the positive electrode and using a lithium-free material, such as a carbonaceous or Si-based material, for the negative electrode. In addition, lithium ions intercalated at the positive electrode migrate to the negative electrode through the electrolyte during charging, while lithium ions migrate back to the positive electrode from the negative electrode during discharging. During charging, lithium migrating from the positive electrode to the negative electrode reacts with the electrolyte to form a solid electrolyte interface (SEI) layer as a kind of passivation film on the surface of the negative electrode. The SEI layer reduces the direct contact between the negative electrode and the electrolyte to prevent additional decomposition of the electrolyte after the formation of the SEI layer, thereby stabilizing the structure of the negative electrode and minimizing the electrolyte consumption. Meanwhile, since the reaction of SEI layer formation is irreversible, it causes consumption of electrolyte additives and lithium ions at the initial stage of activation or cycle. In addition, the active material itself has a zone allowing irreversible lithium consumption depending on its structure, and lithium ions are not deintercalated from such a zone after charging, resulting in lithium-ion consumption. In other words, lithium consumed through the reaction at the negative electrode during the initial activation stage does not return to the positive electrode during the subsequent discharging process to cause a decrease in the capacity of a battery, and such a phenomenon is called irreversible capacity.

A carbonaceous material, such as graphite, as a negative electrode material has high stability and reversibility, but is limited in terms of capacity. Therefore, a silicon (Si)-based material having a high theoretical capacity has been used as a negative electrode material in the field requiring high capacity. However, the Si-based material undergoes a change in crystal structure during charging/discharging according to lithium-ion intercalation/deintercalation, followed by rapid volumetric swelling. The Si-based material causing volumetric swelling shows high initial irreversible capacity and causes severe lithium depletion, and thus provides low initial efficiency. Moreover, as charge/discharge cycles are repeated, the Si-based material causes degradation of life characteristics due to the additional SEI reaction at the surface of the newly exposed active material.

For example, referring to the charging profile of a lithium secondary battery including an Si-based negative electrode, lithium ions are intercalated to the Si-based material during charging to form LiₓSi compounds, such as Li₁₂Si₇, Li₂Si, Li₂₁Si₈, Li₁₅Si₄ and Li₂₂Si₅, but only Li₂Si or Li₂₁Si₈ of them shows a reversible charge/discharge behavior and the others do not.

Therefore, when charging is made beyond the ranges of Li₂Si or Li₂₁Si₈ showing a reversible charge/discharge behavior at the Si-based negative electrode, the negative electrode shows a large change in thickness due to the volumetric swelling to cause deterioration of the conductive network in the negative electrode, resulting in an electric short-circuit and a problem in charge/discharge characteristics. When such phenomena are accumulated, cracking occurs on the surface of the negative electrode active material, resulting in the problem of rapid electrolyte consumption.

Under these circumstances, there has been an attempt to carry out pre-lithiation as a technology of inhibiting the initial irreversible capacity or volumetric swelling of a negative electrode. In other words, there has been attempted a method of preliminarily carrying out the irreversible reaction of the negative electrode or slightly intercalating lithium at the negative electrode before manufacturing a battery to ensure initial reversibility and to improve the capacity and electrochemical performance of the battery. However, despite such an attempt, there have been problems of degradation of discharge capacity or life characteristics. In addition, when lithium metal is used directly for such pre-lithiation, lithium itself easily reacts with oxygen, nitrogen and carbon dioxide because it is unstable in the air, resulting in the problems of a difficulty in handling and a high risk of ignition and explosion.

### SUMMARY

To solve the above-mentioned problems, the present disclosure is directed to providing a composite negative electrode material for a lithium secondary battery which can retain an excellent conductive network even in the case of the volumetric swelling of an Si-based negative electrode, a method for preparing the composite negative electrode material for a lithium secondary battery, and a negative electrode for a lithium secondary battery including the same.

The present disclosure adopts a method different from the methods of the related art to introduce lithium to the negative electrode by using gaseous lithium obtained by vaporizing a lithium-containing compound (e.g. lithium metal, lithium oxide, lithium hydroxide, lithium alloy) as a reducing material. In this manner, lithium can be introduced safely to the negative electrode, thereby providing an effect of inhibiting the irreversibility and volumetric swelling of the negative electrode.

The objects of the present disclosure are not limited to the above-mentioned objects, and other objects and advantages of the present disclosure that are not mentioned may be understood by the following description and will be more clearly understood by embodiments of the present disclosure. In addition, it will be easily understood that the objects and advantages of the present disclosure may be realized by the means described in the specification and a combination thereof.

According to the first embodiment of the present disclosure, there is provided a composite negative electrode material for a lithium secondary battery, including a lithium silicate matrix and silicon.

According to the second embodiment of the present disclosure, the lithium silicate matrix may include at least one compound selected from the group consisting of lithium orthosilicate (Li₄SiO₄), lithium metasilicate (Li₂Si₂O₅) and lithium disilicate (Li₂SiO₃).

According to the third embodiment of the present disclosure, lithium orthosilicate may be present in an amount of 15-55 wt %, lithium metasilicate may be present in an amount of 45-90 wt %, and lithium disilicate may be present in an amount of 0.01-0.5 wt %, based on the total weight of the three compounds of lithium orthosilicate, lithium metasilicate and lithium disilicate, except silicon, in the composite negative electrode material for a lithium secondary battery, including the lithium silicate matrix and silicon.

According to the fourth embodiment of the present disclosure, lithium orthosilicate may be present in an amount of 5-35 wt %, lithium metasilicate may be present in an amount of 30-60 wt %, and lithium disilicate may be present in an amount of 0.01-0.4 wt %, when the content of silicon in the lithium silicate matrix is maintained at 40-45 wt % based on the total weight of the lithium silicate matrix and silicon particles.

According to the fifth embodiment of the present disclosure, the composite negative electrode material for a lithium secondary battery, including a lithium silicate matrix and silicon, may have an average particle diameter of 1-20 μm.

According to the sixth embodiment of the present disclosure, the composite negative electrode material for a lithium secondary battery may further include a carbonaceous material.

According to the seventh embodiment of the present disclosure, the carbonaceous material may be at least one compound selected from the group consisting of graphene, carbon nanotubes (CNTs), carbon fibers, crystalline carbon and amorphous carbon.

According to the eighth embodiment of the present disclosure, there is provided a negative electrode for a lithium secondary battery, including the composite negative electrode material for a lithium secondary battery.

According to the ninth embodiment of the present disclosure, the negative electrode for a lithium secondary battery may have an electrode density of 1.2 g/cm³ or less.

According to the tenth embodiment of the present disclosure, there is provided a method for preparing a composite negative electrode material, including the steps of:
(S1) mixing Si with SiO₂ to prepare a silicon (SiOₓ, 0<x<2) mixture,
(S2) adding a lithium compound to the silicon mixture to prepare a silicon-lithium mixture; and
(S3) heating the silicon-lithium mixture.

According to the eleventh embodiment of the present disclosure, Si and SiO₂ may be mixed at a molar ratio of 1:0.7-1:1.5 in step (S1).

According to the twelfth embodiment of the present disclosure, the silicon mixture and the lithium compound may be further incorporated at a molar ratio of 1:1-1:1.5 in step (S2).

According to the thirteenth embodiment of the present disclosure, the lithium compound in step (S2) may be at least one compound selected from the group consisting of lithium metal, lithium oxide, lithium carbonate, lithium hydroxide and lithium alloy.

According to the fourteenth embodiment of the present disclosure, the silicon-lithium mixture may be heated at 500-1,500° C. for 2-7 hours in step (S3).

According to the fifteenth embodiment of the present disclosure, the method for preparing a composite negative electrode material may further include step (S4) of introducing a carbonaceous material to the composite negative electrode material.

According to the sixteenth embodiment of the present disclosure, there is provided a negative electrode for a lithium secondary battery, including the composite negative electrode material.

According to the seventeenth embodiment of the present disclosure, the negative electrode for a lithium secondary battery may have a tap density of 1.0-1.6 g/cm³.

The above Technical Solution part does not list all the features of the present disclosure. Various features of the present disclosure and advantages and effects thereof may be understood in more detail with reference to the detailed description below.

According to an aspect of the present disclosure, the composite negative electrode material can maintain the conductive network even in the case of the volumetric swelling caused by charging/discharging, and thus can provide a negative electrode for a lithium secondary battery capable of realizing excellent electrochemical performance.

In addition to the above-described effects, specific effects of the present disclosure are described together with detailed description for implementing the present disclosure. In addition, the effects of the present disclosure are not limited to the above-mentioned effects and may be easily implemented by the means described in the specification and a combination thereof.

### BRIEF DESCRIPTION OF THE DRAWINGS

FIG. 1 is a schematic view illustrating the method for preparing a composite negative electrode material according to an embodiment of the present disclosure.

FIG. 2 shows an X-ray diffraction (XRD) pattern of the composite negative electrode material prepared according to an embodiment of the present disclosure.

FIGS. 3A and 3B show the composite negative electrode material prepared according to an embodiment of the present disclosure, as observed by using HIGH ANGLE ANNULAR DARK FIELD IMAE (HADDF)-TEM, ENERGY-DISPERSIVE X-RAY SPECTROSCOPY (EDX), ELECTRON ENERGY LOSS SPECTROSCOPY (EELS).

FIG. 4 shows the rate characteristics of the composite negative electrode material prepared according to an embodiment of the present disclosure.

FIG. 5 shows the life characteristics of the composite negative electrode material prepared according to an embodiment of the present disclosure.

FIGS. 6A and 6B show the charge/discharge test results of the composite negative electrode material prepared according to an embodiment of the present disclosure as a function of tap density.

### DETAILED DESCRIPTION

In the present specification, singular expressions include plural expressions, unless otherwise stated.

When several means for solving problems are described in the specification, the effects of the present disclosure may be defined as including not only the functional effects derived from each means itself, but also the effects generated by organically combining the means. For example, even if means 1 and means 2 are described independently in this specification, the effect generated by the organic combination of the means 1 and means 2 may be included in the effect of the present disclosure, unless otherwise stated.

The range of values expressed by using the terms ‘to’ in the present specification represents a range of values including the values described before and after the term as a lower limit value and an upper limit value, respectively. When a plurality of numerical values of an upper limit and a lower limit of an arbitrary numerical range are disclosed, the range of values disclosed in the present specification may be understood as a range of any one of a plurality of lower limit values and any one of a plurality of upper limit values as a lower limit value and an upper limit value, respectively. For example, when ‘a to b’ or ‘c to d’ is described in the specification, it may be understood that ‘a or more and b or less’, ‘a or more and d or less’, ‘c or more and d or less’, or ‘c or more and b or less’ are described.

In the present specification, terms such as “about” or “substantially” refer to reasonable deviations of a term modified so that the final result does not significantly change. These terms may be interpreted as including at least ±5% or at least ±10% of deviation as long as the deviation does not modify and invalidate the meaning of the word.

In one aspect of the present disclosure, there is provided a method for preparing a composite negative electrode material for a lithium secondary battery including a lithium silicate (LiₓSi_{y}O_{z}) matrix and silicon particles, and a method for preparing the composite negative electrode material (wherein, 2≤x≤4, 1≤y≤2, and 3≤z≤5).

As described above, a graphite-based negative electrode material is widely known as a negative electrode material for a lithium secondary battery, and such a graphite-based negative electrode material shows excellent structural stability even when lithium intercalation/deintercalation occurs, thereby providing stable capacity retention characteristics even after long cycles. However, the graphite-based negative electrode material has a low theoretical capacity (about 350 mAh/g) and is not suitable as a currently desired high-capacity high-output material. Therefore, an Si-based negative electrode material including Si or SiOₓ and having a theoretical capacity (~4,200 mAh/g for Li_{4.4}Si) approximately 10 times higher than the theoretical capacity of graphite has been spotlighted.

However, the Si-based negative electrode material consumes approximately three times more lithium than the graphite-based negative electrode material and shows the problem of an increase in irreversible capacity. To solve the problem of initial capacity, caused by irreversible reaction of lithium ions, there has been an attempt to carry out pre-lithiation so that the initial efficiency may be improved. However, when preparing a negative electrode material slurry using a pre-lithiated Si-based negative electrode material, the lithium compound formed by pre-lithiation reacts with H₂O to produce LiOH as a byproduct and causes increased hydrogen generation, resulting in a change in slurry viscosity and degradation of slurry coating property, which causes severe defects in slurry coating. As a result, fatal problems, such as a rapid drop in capacity caused by an electrical short-circuit with a current collector, may occur.

Under these circumstances, the present inventors have found that a composite negative electrode material including a lithium silicate (LiₓSi_{y}O_{z}) matrix and silicon particles can solve the above-mentioned problems. The present disclosure is based on this finding.

Hereinafter, the composite negative electrode material according to the present disclosure will be explained in more detail.

### 1. Composite Negative Electrode Material

In one aspect of the present disclosure, there is provided a composite negative electrode material for a lithium secondary battery, including a lithium silicate matrix and silicon particles.

According to an embodiment of the present disclosure, the lithium silicate matrix may include at least one compound selected from the group consisting of lithium orthosilicate (Li₄SiO₄), lithium metasilicate (Li₂Si₂O₅) and lithium disilicate (Li₂SiO₃).

In the composite negative electrode material for a lithium secondary battery according to the present disclosure, silicon is directly bound with lithium and turns into amorphous lithium silicate (c-Si+xLi*a-LiₓSi_{y}) from crystalline silicon (c-Si), and into amorphous silicon (a-Si) after delithiation. Herein, as crystalline silicon turns into amorphous lithium silicate, volumetric swelling may occur significantly, wherein the lithium silicate matrix may function to inhibit such volumetric swelling of silicon.

According to an embodiment of the present disclosure, the silicon particles may be present in the lithium silicate matrix, and the silicon particles in the lithium silicate matrix may be Si or SiOₓ (0<x<2).

According to an embodiment of the present disclosure, the silicon particles may have an average particle diameter of 5-100 nm, or 1-10 μm.

According to an embodiment of the present disclosure, the composite negative electrode material for a lithium secondary battery may include the silicon particles in an amount of 20-80 parts by weight, preferably 20-70 parts by weight, based on 100 parts by weight of the composite negative electrode material. Herein, when the proportion of the silicon particles is excessively high, volumetric swelling occurs significantly during charging/discharging, thereby making it difficult to control the volumetric change of the electrode. On the other hand, when the proportion of the silicon particles is excessively low, absolute charge/discharge capacity may be decreased undesirably.

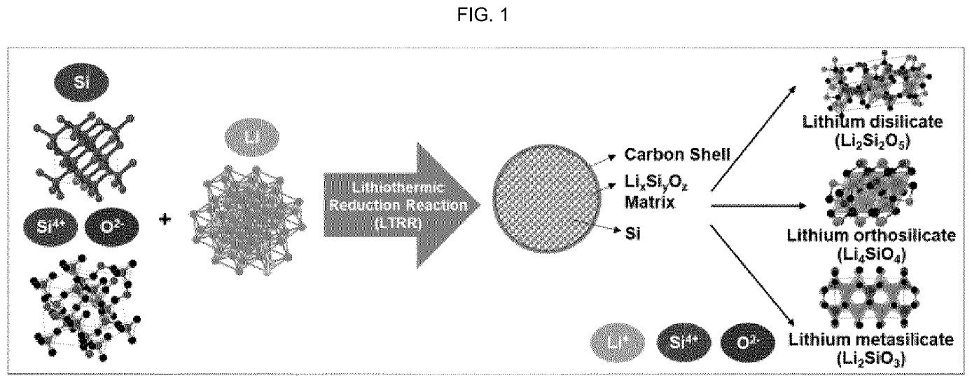

The lithium silicate matrix forming the composite negative electrode material according to the present disclosure is a compound represented by the general formula of LiₓSi_{y}O_{z} and forms a shape of matrix while lithium orthosilicate, lithium metasilicate and lithium disilicate form a network together (see FIG. 1). The lithium silicate matrix alleviates volumetric swelling even when the silicon particles undergo significant volumetric swelling according to charging/discharging, and thus can function to reduce the irreversible capacity of a battery and to improve the electrochemical performance of a battery.

According to an embodiment of the present disclosure, lithium orthosilicate may be present in an amount of 15-55 wt %, preferably 16-51 wt %, lithium metasilicate may be present in an amount of 45-90 wt %, preferably 49-84 wt %, and lithium disilicate may be present in an amount of 0.01-0.5 wt %, preferably 0.01-0.31 wt %, based on the total weight of the three compounds of lithium orthosilicate, lithium metasilicate and lithium disilicate, except silicon, in the composite negative electrode material for a lithium secondary battery, including the lithium silicate matrix and silicon.

Meanwhile, the weight ratio of the three compounds of lithium orthosilicate, lithium metasilicate and lithium disilicate may be varied while maintaining the weight of silicon in the lithium silicate matrix constantly. According to an embodiment of the present disclosure, the content of each of lithium orthosilicate, lithium metasilicate and lithium disilicate may be varied, while maintaining the content of silicon in the lithium silicate matrix at 40-45 wt % based on the total weight of the lithium silicate matrix and silicon particles. Herein, lithium orthosilicate may be present in an amount of 5-35 wt %, preferably 10-32 wt %, lithium metasilicate may be present in an amount of 30-60 wt %, preferably 31-55 wt %, and lithium disilicate may be present in an amount of 0.01-0.4 wt %, preferably 0.01-0.2 wt %.

According to an embodiment of the present disclosure, the composite negative electrode material for a lithium secondary battery, including a lithium silicate matrix and silicon, may have an average particle diameter of 1-20 μm, preferably 1-15 μm.

Meanwhile, the composite negative electrode material for a lithium secondary battery according to the present disclosure may further include a carbonaceous material.

The carbonaceous material helps to maintain the lithium silicate matrix in the composite negative electrode material more firmly. The composite negative electrode material according to the present disclosure may use an aqueous binder showing high binding force due to a large change in volume during charging/discharging. Herein, lithium silicate may react with water as a solvent of the aqueous binder to be decomposed into LiOH and SiO₂, but the carbonaceous material maintains the lithium silicate matrix firmly and thus can reduce a possibility of the reaction between water and lithium silicate.

According to an embodiment of the present disclosure, the carbonaceous material may be present as coating with which the lithium silicate matrix is coated, in the composite negative electrode material. Since the carbonaceous material is present as coating with which the lithium silicate matrix is coated, it is possible to effectively interrupt the reaction between lithium silicate and water.

According to an embodiment of the present disclosure, the carbonaceous material may be at least one compound selected from the group consisting of graphene, carbon nanotubes (CNTs), carbon fibers, crystalline carbon and amorphous carbon. In terms of electrical conductivity and alleviation of a change in volume during charging/discharging, graphene is most preferred.

Herein, crystalline carbon may be graphite, such as amorphous, sheet-like, flake, spherical or fibrous natural or artificial graphite, and amorphous carbon may be soft carbon (low-temperature baked carbon) or hard carbon, mesophase pitch carbide, baked cokes or a mixture thereof.

Herein, crystalline carbon or amorphous carbon, graphene or carbon nanotubes may have a controlled I_{D}/I_{G} ratio through additional heat treatment, and a ratio of I_{D}/I_{G} of 1.0 or less is more preferred (I_{D}/I_{G} is a relative intensity ratio of D band peak to G band peak in a Raman spectrum and refers to a ratio of the maximum peak intensity (I_{D}) of D band at 1,360±50 cm⁻¹ to the maximum peak intensity (I_{G}) of G band at 1,580±50 cm⁻¹, as determined by Raman spectroscopy using laser with a wavelength of 532 nm).

According to an embodiment of the present disclosure, the carbonaceous material may have an average particle diameter of 10-500 nm, preferably 20-300 nm, and more preferably 5-50 nm.

According to an embodiment of the present disclosure, the composite negative electrode material for a lithium secondary battery may have a D₅₀ of 3-10 μm.

According to an embodiment of the present disclosure, the composite negative electrode material for a lithium secondary battery may have a specific surface area of 1-10 m²/g.

In another aspect of the present disclosure, there is provided a method for preparing a composite negative electrode material. According to the present disclosure, the composite negative electrode material may be obtained by Lithiothermic Reduction Reaction (LTRR). Particularly, the present disclosure provides a method for preparing a composite negative electrode material, including the steps of:
(S1) mixing Si with SiO₂ at a molar ratio of 1:0.7-1:1.5 to prepare a silicon (SiOₓ, 0<x<2) mixture,
(S2) mixing the silicon mixture with a lithium compound at a molar ratio of 1:1-1:1.5 to prepare a silicon-lithium mixture; and
(S3) heating the silicon-lithium mixture.

The inventors of the present disclosure have found that when a lithium-containing composite negative electrode material is prepared by using a method based on Lithiothermic Reduction Reaction (LTRR), particularly using gaseous state lithium, lithium orthosilicate, lithium metasilicate and lithium disilicate can be incorporated effectively into the matrix.

Meanwhile, the method may further include step (S4) of introducing a carbonaceous material to the composite negative electrode material. The carbonaceous material may be introduced by using a known method. For example, the carbonaceous material may be introduced to the composite negative electrode material through chemical vapor deposition (CVD) or simple mixing.

According to an embodiment of the present disclosure, the molar ratio of Si to SiO₂ may be 1:0.7-1:1.5 preferably in step (S1). Herein, when SiO₂ is mixed at a ratio of 100 mol % or less based on Si in step (S1), the final product, Li₂Si₂O₅ may not be formed undesirably.

According to an embodiment of the present disclosure, the molar ratio of the silicon mixture to the lithium compound may be 1:1-1:1.5 preferably in step (S2). When the molar ratio of the silicon mixture to the lithium compound does not fall within the above-defined range, unreacted SiO₂ may be present undesirably.

According to an embodiment of the present disclosure, the lithium compound in step (S2) may be at least one compound selected from the group consisting of lithium metal, lithium oxide, lithium hydroxide and lithium alloy, and lithium metal is most preferred in terms of production of gaseous state lithium.

According to an embodiment of the present disclosure, the silicon-lithium mixture may be heated at 500-1,500° C., preferably 500-1,000° C., for 2-7 hours in step (S3).

The heating temperature is a temperature where Si and SiO₂ are present in a solid state at the same time and lithium is present in a gaseous state. Since Lithiothermic Reduction Reaction (LTRR) is a reaction carried out by using gaseous lithium (Li (g)), the above-defined heating temperature range is essential to realize the method according to the present disclosure.

### 2. Negative Electrode

In another aspect of the present disclosure, there is provided a lithium secondary battery including: a negative electrode including the above-described composite negative electrode material; a positive electrode; a separator; and an electrolyte.

Particularly, the lithium secondary battery according to the present disclosure may be obtained by injecting an electrolyte to an electrode assembly including a positive electrode, a negative electrode and a separator interposed between the negative electrode and the positive electrode. Herein, the positive electrode, the negative electrode and the separator forming the electrode assembly may be those used conventionally for manufacturing a lithium secondary battery.

First, the negative electrode may be obtained by forming a negative electrode mixture layer on a negative electrode current collector. The negative electrode mixture layer may be formed by coating a slurry containing the composite negative electrode material, a binder, a conductive material and a solvent on a negative electrode current collector, followed by drying and pressing.

The negative electrode current collector is not particularly limited, as long as it has high conductivity while not causing any chemical change in the corresponding battery. Particularly, the negative electrode current collector may include at least one selected from the group consisting of copper, stainless steel, aluminum, nickel, titanium, baked carbon and aluminum-cadmium alloy, and preferably may include copper.

The negative electrode current collector may generally have a thickness of 3-500 μm.

In addition, fine surface irregularities may be formed on the surface of the negative electrode current collector to reinforce the binding force with the composite negative electrode material. For example, the negative electrode current collector may be used in various shapes, including a film, a sheet, a foil, a net, a porous body, a foamed body, a non-woven web, or the like.

The slurry containing the composite negative electrode material is applied onto the negative electrode current collector. After the slurry is applied onto the negative electrode current collector, pressing and drying may be carried out to form a composite negative electrode material layer.

The slurry may be applied to one surface or both surfaces of the negative electrode current collector. When the slurry is applied to both surfaces of the negative electrode current collector, the composite negative electrode material layers may be formed on both surfaces of the negative electrode current collector.

The composite negative electrode material may be contained in the negative electrode slurry in an amount of 50-85 wt %, preferably 65-80 wt %, based on the solid content of the negative electrode slurry with a view to sufficient realization of high capacity of silicon in the secondary battery, while minimizing the effect of volumetric swelling/shrinking of silicon upon the battery.

The slurry may further include a negative electrode conductive material and/or negative electrode binder together with the composite negative electrode material. The negative electrode binder may be used to improve the adhesive force of the Si-based material with the negative electrode current collector, or to improve the binding force of the Si-based material. Particularly, the negative electrode binder may include at least one selected from the group consisting of styrene butadiene rubber (SBR), acrylonitrile butadiene rubber, acrylic rubber, butyl rubber, fluoro-rubber, polyvinylidene fluoride (PVDF), polyvinyl alcohol, carboxymethyl cellulose (CMC), starch, hydroxypropyl cellulose, regenerated cellulose, polyvinyl alcohol (PVA), polyacrylic acid (PAA), polyethylene glycol (PEG), polyacrylonitrile (PAN) and polyacrylamide (PAM) in terms of further improving the electrode adhesion and imparting sufficient resistance against the volumetric swelling/shrinking of the Si-based active material.

The negative electrode binder may be contained in the negative electrode slurry in an amount of 5-30 wt %, preferably 10-25 wt %, based on the solid content of the negative electrode slurry. When the negative electrode binder is used within the above-defined range, it is possible to perform sufficient binding of silicon to minimize the problem of volumetric swelling of the active material, while facilitating dispersion of the negative electrode binder in preparing the slurry for forming the composite negative electrode material layer and improving the coatability and phase stability of the slurry.

The negative electrode conductive material may be used to assist and improve the conductivity, and is not particularly limited as long as it has conductivity while not causing any chemical change. Particularly, the negative electrode conductive material may include at least one selected from the group consisting of graphite, such as natural graphite or artificial graphite; carbon black, such as acetylene black, ketjen black, channel black, furnace black, lamp black or thermal black; conductive fibers, such as carbon fibers or metal fibers; conductive tubes, such as carbon nanotubes; fluoro-carbon; conductive whisker, such as zinc oxide or potassium titanate; conductive metal oxide, such as titanium dioxide; and polyphenylene derivatives. Preferably, the negative electrode conductive material may include carbon black in terms of realizing high conductivity.

The negative electrode conductive material may have a specific surface area of 80-200 m²/g, preferably 100-150 m²/g, in terms of facilitating dispersion of the negative electrode conductive material in preparing the slurry for forming a composite negative electrode material layer and further improving electrical conductivity.

The negative electrode conductive material may be contained in the negative electrode slurry in an amount of 5-20 wt %, preferably 7-15 wt %, based on the solid content of the negative electrode slurry. Within the above-defined range, it is possible to form an excellent conductive network, while reducing an increase in resistance caused by the negative electrode binder.

Meanwhile, according to an embodiment of the present disclosure, a metal element-containing material (e.g. metal powder) may be used as a conductive material, besides the above-described carbon-based materials. The metal element-containing material may be a material containing at least one element selected from the group consisting of silver (Ag), gold (Au), tin (Sn), copper (Cu), nickel (Ni) and zinc (Zn), and preferably, may be provided in the form of alloy. In addition, a metal capable of alloying with lithium may be used as a conductive material.

Herein, the metal capable of alloying with lithium may be Si, Sn, Al, Ge, Pb, Bi, Sb, Si—Y alloy (wherein Y is an alkali metal, alkaline earth metal, Group 13 element, Group 14 element, transition metal, rare earth metal element or a combination thereof, and is not Si), Sn—Y alloy (wherein Y is an alkali metal, alkaline earth metal, Group 13 element, Group 14 element, transition metal, rare earth metal element or a combination thereof, and is not Sn), or the like.

The element, Y may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, or Te.

In addition, the metal element-containing material may have a shape of particles or wires.

The negative electrode slurry may further include a solvent for forming a negative electrode slurry for the purpose of mixing and dispersion of the composite negative electrode material, the negative electrode binder and the negative electrode conductive material. For example, the solvent for forming a negative electrode slurry may include at least one selected from the group consisting of N-methyl-2-pyrrolidone (NMP), distilled water, ethanol, methanol and isopropyl alcohol, preferably distilled water, in terms of facilitating dispersion of the composite negative electrode material, the negative electrode binder and the negative electrode conductive material.

The negative electrode slurry may have a solid content of 20-35 wt %, preferably 23-30 wt %. Within the above-defined range, the negative electrode slurry may have an adequately reduced level of viscosity, which is advantageous to coating of the composite negative electrode material layer at a low loading amount.

### 3. Positive Electrode

According to an embodiment of the present disclosure, the positive electrode used in combination with the negative electrode including the composite negative electrode material may include a current collector, and a positive electrode mixture layer formed on the current collector. The positive electrode mixture layer may be formed by coating a positive electrode slurry containing a positive electrode active material, a binder, a conductive material and a solvent onto the positive electrode current collector, followed by drying and pressing.

The positive electrode active material is a compound capable of reversible lithiation and delithiation, and particularly, may include a lithium composite metal oxide containing at least one metal, such as cobalt, manganese, nickel or aluminum, and lithium. More particularly, the lithium composite metal oxide may include lithium manganese-based oxides (e.g. LiMnO₂, LiMn₂O₄, etc.), lithium cobalt-based oxides (e.g. LiCoO₂, etc.), lithium nickel-based compounds (e.g. LiNiO₂, etc.), lithium nickel manganese-based oxides (e.g. LiNi_{1-Y}Mn_{Y}O₂ (wherein 0<Y<1), LiMn_{2-z}Ni_{z}O₄ (wherein 0<Z<2), etc.), lithium nickel cobalt-based oxides (e.g. LiNi_{1-Y1}Co_{Y1}O₂ (wherein 0<Y1<1), etc.), lithium manganese cobalt oxides (e.g. LiCo_{1-Y2}Mn_{Y2}O₂ (wherein 0<Y2<1), LiMn_{2-z1}Co_{z1}O₄ (wherein 0<Z1<2), etc.), lithium nickel manganese cobalt-based oxides (e.g. Li(NiₚCo_{q}Mnᵣ₁)O₂ (wherein 0<p<1, 0<q<1, 0<r1<1, p+q+r1=1) or Li(Niₚ₁Co_{q1}Mnᵣ₂)O₄ (wherein 0<p1<2, 0<q1<2, 0<r2<2, p1+q1+r2=2), etc.), or lithium nickel cobalt transition metal (M)-based oxides (e.g. Li(Niₚ₂Co_{q2}Mnᵣ₃Mₛ₂)O₂ (wherein M is selected from the group consisting of Al, Fe, V, Cr, Ti, Ta, Mg and Mo, each of p2, q2, r3 and s2 represents the atomic fraction of each independent element, and 0<p2<1, 0<q2<1, 0<r3<1, 0<s2<1, p2+q2+r3+s2=1), and such lithium composite metal oxides may be used alone or in combination.

Among them, the lithium composite metal oxide may be LiCoO₂, LiMnO₂, LiNiO₂, lithium nickel manganese cobalt oxides (e.g. Li(Ni_{1/3}Mn_{1/3}Co_{1/3})O₂, Li(Ni_{0.6}Mn_{0.2}Co_{0.2})O₂, Li(Ni_{0.5}Mn_{0.3}Co_{0.2})O₂, Li(Ni_{0.7}Mn_{0.15}Co_{0.15})O₂, Li(Ni_{0.8}Mn_{0.1}Co_{0.1})O₂, etc.), lithium nickel cobalt aluminum oxides (e.g. Li(Ni_{0.8}Co_{0.15}Al_{0.05})O₂, etc.), or the like, in terms of improvement of the capacity characteristics and stability of a battery.

The positive electrode active material may be used in an amount of 80-99 wt % based on the total weight of the solid content of the positive electrode slurry.

The binder is an ingredient which assists the binding of the active material with the conductive material, or the like, and the binding to the current collector, and is added generally in an amount of 1-30 wt % based on the total weight of the solid content of the positive electrode slurry. Particular examples of the binder may include polyvinylidene fluoride (PVDF), polyvinyl alcohol, carboxymethyl cellulose (CMC), starch, hydroxypropyl cellulose, regenerated cellulose, polyvinyl pyrrolidone, tetrafluoroethylene, polyethylene, polypropylene, ethylene-propylene-diene terpolymer (EPDM), sulfonated EPDM, styrene-butadiene rubber, fluoro-rubber, various copolymers, or the like.

In general, the conductive material is added in an amount of 1-30 wt % based on the total weight of the solid content of the positive electrode slurry.

The conductive material is not particularly limited, as long as it has conductivity while not causing any chemical change in the corresponding battery. For example, the conductive material may include: graphite, carbonaceous materials, such as carbon black, acetylene black, ketjen black, channel black, furnace black, lamp black, thermal black; conductive fibers, such as carbon fibers or metal fibers; fluoro-carbon; metal powder, such as, aluminum or nickel powder; conductive whisker, such as zinc oxide or potassium titanate; conductive metal oxide, such as titanium dioxide; conductive materials, such as a polyphenylene derivative; or the like. Particular examples of commercially available conductive materials may include acetylene black series (available from Chevron Chemical Company), denka black (available from Denka Singapore Private Limited, Gulf Oil Company, etc.), Ketjen black, EC series (available from Armak Company), Vulcan XC-72 (available from Cabot Company), and Super P (available from Timcal Co.), or the like.

The solvent may include an organic solvent, such as N-methyl-2-pyrrolidone (NMP), and may be used in such an amount that a desired level of viscosity may be accomplished when the positive electrode active material is incorporated thereto optionally with the binder, the conductive material, or the like. For example, the solvent may be used in such a manner that the slurry containing the positive electrode active material optionally with the binder and the conductive material may have a solid content of 50-95 wt %, preferably 70-90 wt %.

### 4. Separator

In addition, the separator functions to interrupt an initial short-circuit between both electrodes and to allow wetting with an electrolyte, and may be formed by mixing a polymer resin, a filler and a solvent to prepare a separator composition and coating the separator composition directly on the top of an electrode, followed by drying, to form a separator film. In a variant, the separator may be formed by casting the separator composition on a support, followed by drying, and then laminating the separator peeled from the support on the top of an electrode.

In general, the separator may include a conventionally used porous polymer film, such as a porous polymer film made of a polyolefin-based polymer, such as ethylene homopolymer, propylene homopolymer, ethylene/butene copolymer, ethylene/hexene copolymer or ethylene/methacrylate copolymer, or a laminate thereof. In a variant, a porous nonwoven web used conventionally in the art, such as a nonwoven web including glass fibers having a high melting point, polyethylene terephthalate fibers, or the like, may be used. However, the scope of the present disclosure is not limited thereto.

Herein, the porous separator may generally have a pore diameter of 0.01-50 μm and a porosity of 5-95%. In addition, the porous separator may generally have a thickness of 5-300 μm.

Although the outer shape of the lithium secondary battery according to the present disclosure is not particularly limited, the lithium secondary battery may have a cylindrical, prismatic, pouch-like or coin-like shape.

Examples will be described more fully hereinafter so that the present disclosure can be understood with ease. However, the following examples are for illustrative purposes only, and the scope of the present disclosure is not limited thereto.

### Preparation Example 1: Preparation of Si/LiₓSi_{y}O_{z} Composite Negative Electrode Active Material

To prepare the composite negative electrode material according to the present disclosure, Lithiothermic Reduction Reaction (LTRR) method was used. Particularly, SiO powder was mixed with SiO₂ powder at a molar ratio of 1:0.7-1.5, and ball milling was carried out to prepare a silicon (SiOₓ, 0<x<2) mixture. Then, the silicon mixture was mixed with lithium metal at a molar ratio of 1:1.3-1.4, and the resultant mixture was introduced to a stainless steel tube filled with argon and heated at 1,500° C. for 3 hours to carry out reaction of gaseous state lithium (LI (g)) with the silicon mixture to obtain a composite negative electrode material, Si/LiₓSi_{y}O_{z}.

### Preparation Example 2: Preparation of Electrode

### Example 1: Electrode Including Composite Negative Electrode Material Si/LiₓSi_{y}O_{z}/C

Based on the total weight of the composite negative electrode material, 60 wt % of the composite negative electrode material, Si/LiₓSi_{y}O_{z}, prepared in Preparation Example 1, 20 wt % of PVDF and 20 wt % of Super-P (conductive material available from Timcal Co.) were mixed, N-methyl-2-pyrrolidone (NMP) was introduced thereto as a solvent, and an electrode slurry was prepared by using a centrifugal mixer. After that, the electrode slurry was coated on copper foil by using a doctor blade and dried in a vacuum oven at 110° C. for 12 hours to obtain an electrode.

### Example 2: Electrode Including Composite Negative Electrode Material Si/LiₓSi_{y}O_{z}@Gr/C

An electrode was obtained in the same manner as Example 1, except that Si/LiₓSi_{y}O_{z}@Gr/C using Si/LiₓSi_{y}O_{z} mixed with graphite was used as a composite negative electrode material, instead of Si/LiₓSi_{y}O_{z}. Based on the total weight of the composite negative electrode material, the graphite and Super P as a conductive material were incorporated in an amount of 72 wt % and 2 wt %, respectively.

### Example 3: Electrode Including Composite Negative Electrode Material Si/LiₓSi_{y}O_{z}@Gr/C

An electrode was obtained in the same manner as Example 2, except that Super P as a conductive material was used in an amount of 5 wt %.

TABLE 1

| | Active material | Graphite | Binder | Conductive |
|---|---|---|---|---|
| | (Si/LiₓSi_{y}O_{z}) | (Gr) | (PVDF) | material (Super P) |
| Ex. 1 | 60 wt % | — | 20 wt % | 20 wt % |
| Ex. 2 | 20 wt % | 72 wt % | 6 wt % | 2 wt % |
| Ex. 3 | 20 wt % | 72 wt % | 3 wt % | 5 wt % |

### Comparative Example 1: Electrode Including Pure Si/C

An electrode was obtained in the same manner as Example 1, except that pure Si (available from Alpha Aesar Co.) was used instead of Si/LiₓSi_{y}O_{z}.

### Test Example 1: X-Ray Diffraction

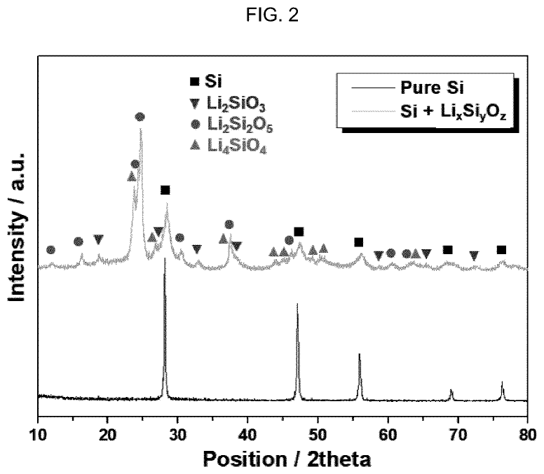

X-ray diffractometry (XRD) was used to determine the crystal structure of Si/LiₓSi_{y}O_{z} prepared from Preparation Example 1. The results are shown in FIG. 2.

Referring to FIG. 2, it can be seen that the structures of lithium silicate and lithium disilicate are well-developed, besides pure Si. In other words, it can be seen that LTRR reaction is accomplished, from the presence of lithium silicate and lithium disilicate, not the peaks of Si and SiO₂ introduced initially to the reaction.

### Test Example 2: Transmission Electron Microscopy (TEM)

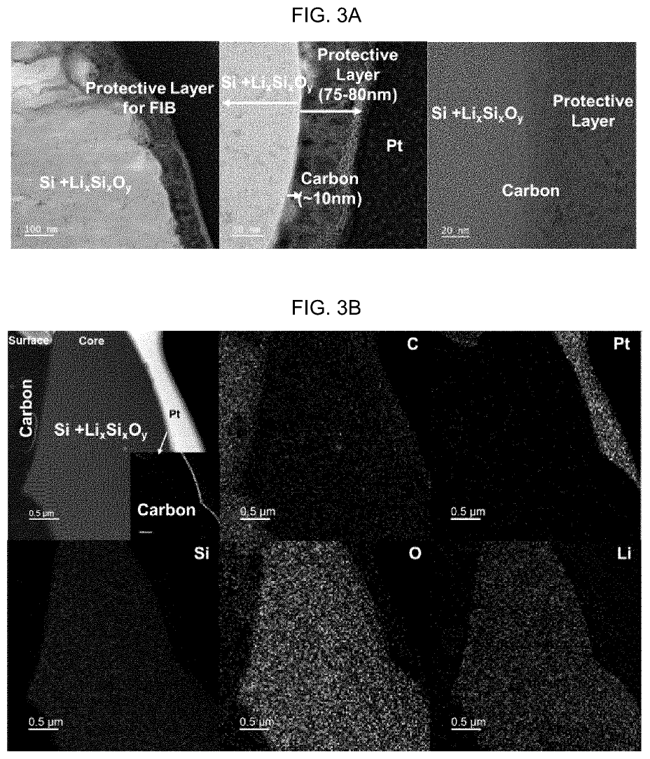

HIGH ANGLE ANNULAR DARK FIELD IMAE (HADDF)-TEM, ENERGY-DISPERSIVE X-RAY SPECTROSCOPY (EDX), ELECTRON ENERGY LOSS SPECTROSCOPY (EELS) was used to observe the distribution of the atoms in the composite negative electrode material. The results are shown in FIGS. 3A and 3B.

Referring to FIGS. 3A and 3B, it can be seen that a carbon layer is coated on silicon and lithium silicate (LiₓSi_{y}O_{z}) and the atoms forming the composite negative electrode material for a lithium secondary battery are distributed homogeneously.

### Test Example 3: Evaluation of Electrochemical Performance

### Manufacture of Battery

The electrode obtained according to each of Examples and Comparative Example 1 and lithium metal (available from Honjo Metal Co.) as a counter electrode were used to obtain a 2032 coin cell. In addition, Cellgard 2400 (available from Asahi Kasei Co.) was used as a separator. Further, used was an electrolyte prepared by dissolving 1.0 M LiPF₆ salt and 10 vol % of fluoroethylene carbonate (FEC) as an additive in a solvent containing ethylene carbonate (EC) mixed with dimethyl carbonate (DMC) at a ratio of 1:1 (v/v).

### Evaluation of Rate Characteristics

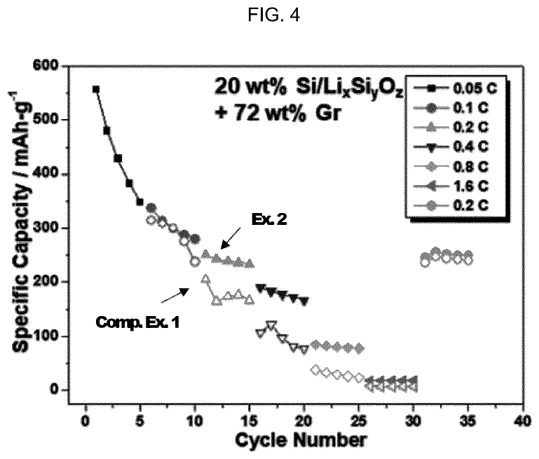

The electrode according to each of Example 2 and Comparative Example 1 was used to obtain a coin cell, and each coin cell was determined in terms of capacity while varying current in a range of 0.05-1.6 C. The results are shown in FIG. 4. As can be seen from FIG. 4, the coin cell using the electrode according to Example 2 realizes higher capacity as compared to the coin cell using the electrode according to Comparative Example 1, even when applying a high level of current.

### Evaluation of Life Characteristics

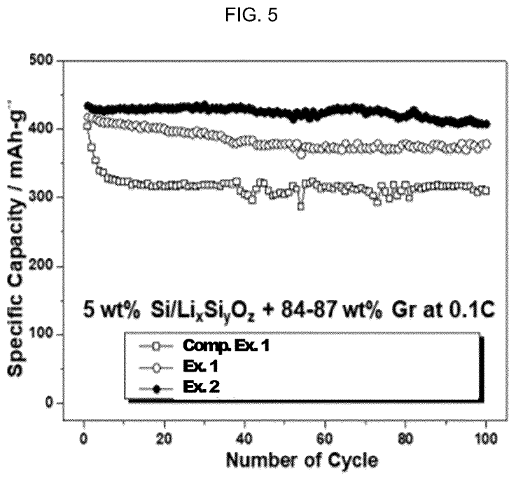

The electrode according to each of Examples 2 and 3 and Comparative Example 1 was used to obtain a coin cell, and each coin cell was determined in terms of capacity depending on cycle number while repeating charge/discharge cycles. The results are shown in FIG. 5. As can be seen from FIG. 5, the coin cell using the electrode according to each of Examples 2 and 3 shows higher life characteristics as compared to the coin cell using the electrode according to Comparative Example 1.

### Evaluation of Initial Coulombic Efficiency

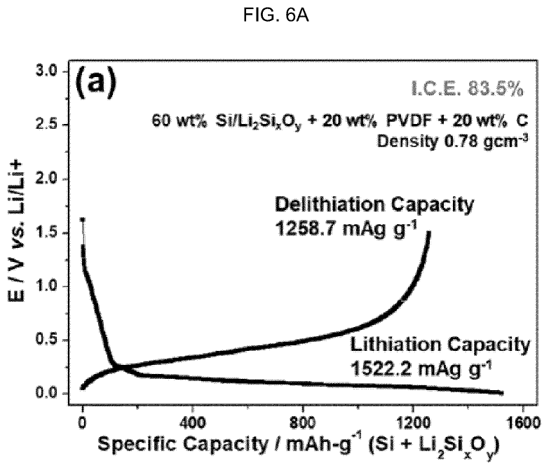

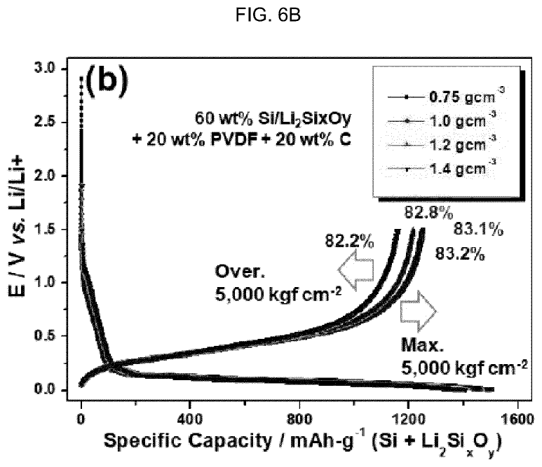

The electrode according to Example 1 was used to obtain a coin cell, and the coin cell was charged/discharged at 0.1 C to determine the initial coulombic efficiency. The results are shown in FIGS. 6A and 6B. Herein, the electrode was pressurized to control the tap density to 1.0-1.6 g/cm³. As can be seen from FIG. 6A and FIG. 6B, even though the electrode according to Example 1 has a relatively low tap density of 0.78 g/cm³, it provides a high coulombic efficiency of 83.5%. It can be also seen that as the tap density of the electrode is increased, the initial coulombic efficiency is decreased due to the exposure of the surface of the active material particles to the electrolyte. In other words, it is significant that the composite negative electrode material according to the present disclosure shows high initial coulombic efficiency even at low tap density.

Although the preferred embodiments of the present disclosure have been described in detail above, the scope of the present disclosure is not limited thereto, and various modifications and improvements of those skilled in the art using the basic concept of the present disclosure defined in the following claims also belong to the scope of the present disclosure.

1: A composite negative electrode material for a lithium secondary battery, comprising a lithium silicate (LiₓSi_{y}O_{z}) matrix and silicon particles wherein 2≤x≤4, 1≤y≤2, and 3≤z≤5.

2: The composite negative electrode material for a lithium secondary battery according to claim 1, wherein the lithium silicate matrix comprises at least one compound selected from the group consisting of lithium orthosilicate, lithium metasilicate and lithium disilicate.

3: The composite negative electrode material for a lithium secondary battery according to claim 2, wherein lithium orthosilicate is present in an amount of 15-55 wt %, lithium metasilicate is present in an amount of 45-90 wt %, and lithium disilicate is present in an amount of 0.01-0.5 wt %, based on the total weight of the three compounds of lithium orthosilicate, lithium metasilicate and lithium disilicate, except silicon, in the composite negative electrode material for a lithium secondary battery, comprising the lithium silicate matrix and silicon.

4: The composite negative electrode material for a lithium secondary battery according to claim 2, wherein lithium orthosilicate is present in an amount of 5-35 wt %, lithium metasilicate is present in an amount of 30-60 wt %, and lithium disilicate is present in an amount of 0.01-0.4 wt %, when the content of silicon in the lithium silicate matrix is maintained at 40-45 wt % based on the total weight of the lithium silicate matrix and silicon particles.

5: The composite negative electrode material for a lithium secondary battery according to claim 1, wherein the lithium silicate matrix comprising the silicon particles has an average particle diameter of 1-20 μm.

6: The composite negative electrode material for a lithium secondary battery according to claim 1, which further comprises a carbonaceous material.

7: The composite negative electrode material for a lithium secondary battery according to claim 6, wherein the carbonaceous material is at least one compound selected from the group consisting of graphene, carbon nanotubes (CNTs), carbon fibers, crystalline carbon and amorphous carbon.

8: The composite negative electrode material for a lithium secondary battery according to claim 6, wherein crystalline carbon or amorphous carbon, graphene or carbon nanotubes has a controlled I_{D}/I_{G} ratio through additional heat treatment, and the ratio of I_{D}/I_{G} is 1.0 or less.

9: A negative electrode for a lithium secondary battery, comprising the composite negative electrode material for a lithium secondary battery as defined in claim 1.

10: The negative electrode for a lithium secondary battery according to claim 9, which has an electrode density of 1.2 g/cm³ or less.

11: A method for preparing a composite negative electrode material, comprising the steps of:
(S1) mixing Si with SiO₂ to prepare a silicon (SiOₓ, 0<x<2) mixture;
(S2) adding a lithium compound to the silicon mixture to prepare a silicon-lithium mixture; and
(S3) heating the silicon-lithium mixture.

12: The method for preparing a composite negative electrode material according to claim 11, wherein Si and SiO₂ are mixed at a molar ratio of 1:0.7-1:1.5 in step (S1).

13: The method for preparing a composite negative electrode material according to claim 11, wherein the silicon mixture and the lithium compound are further incorporated at a molar ratio of 1:1-1:1.5 in step (S2).

14: The method for preparing a composite negative electrode material according to claim 11, wherein the lithium compound in step (S2) is at least one compound selected from the group consisting of lithium metal, lithium oxide, lithium hydroxide and lithium alloy.

15: The method for preparing a composite negative electrode material according to claim 11, wherein the silicon-lithium mixture is heated at 500-1,500° C. for 2-7 hours in step (S3).

16: The method for preparing a composite negative electrode material according to claim 11, which further comprises step (S4) of introducing a carbonaceous material to the composite negative electrode material.

17: A negative electrode for a lithium secondary battery, comprising the composite negative electrode material as defined in claim 1.

18: The negative electrode for a lithium secondary battery according to claim 17, which has a tap density of 0.7-1.6 g/cm³.
